(19) United States
(12) Patent Application Publication
(10) Pub. No.: US 2025/0388143 A1
(43) Pub. Date: Dec. 25, 2025

(54) VEHICLE SEAT

(71) Applicant: Adient US LLC, Plymouth, MI (US)

(72) Inventors: Michael ROTH, Sembach (DE); Thomas GUNDALL, Bedesbach (DE)

(21) Appl. No.: 19/207,593

(22) Filed: May 14, 2025

(30) Foreign Application Priority Data
Jun. 21, 2024 (DE) 10 2024 205 774.6

(51) Int. Cl. B60N 2/68; B60N 2/427

(52) U.S. Cl. CPC B60N 2/682; B60N 2/42709

(57) ABSTRACT

A vehicle seat may have at least one upper frame with at least two upper frame side parts, which are arranged spaced apart from one another in the transverse direction and which are connected to one another via at least one crossbar. At least one of the upper frame side parts may have a protruding insert element. The insert element may be fastened to the upper frame side part via a screw connection and protrudes at least in portions into a cavity of the crossbar.

### FIELD

The invention relates to a vehicle seat comprising at least one transverse frame with at least two transverse frame side parts arranged at a distance from one another in the transverse direction, which are connected to one another via at least one crossbar.

### BACKGROUND

Vehicle seats are known from the prior art which comprise a seat frame and a crossbar arranged on the seat frame, which is connected on both sides to seat frame side parts of the seat frame. The seat frame can, for example, be a component of a seat part of the vehicle seat that serves as a seat surface for a vehicle occupant.

The invention addresses the problem of improving a vehicle seat of the aforementioned type so that in the event of a crash, a connection between the transverse frame side parts and the crossbar is maintained in order to enable safe absorption of impact loads or crash loads.

### SUMMARY

According to the invention, this problem is solved by a vehicle seat according to the specified features of claim 1.

Advantageous embodiments, which can be used individually or in combination with one another, are the subject of the dependent claims.

The vehicle seat according to the invention comprises at least one upper frame with at least two upper frame side parts arranged at a distance from one another in the transverse direction, which are connected to one another via at least one crossbar, wherein at least one of the transverse frame side parts comprises a protruding insert element. The insert element is attached to the upper frame side part via a screw connection and protrudes at least in portions into a cavity in the crossbar.

The fact that the insert element is attached to the upper frame side part via a screw connection and protrudes at least in portions into a hollow space in the crossbar means that a simple, space-saving and effective crash protection system can be provided. In particular, a crash-proof fastening of the upper frame side parts and a seat frame arranged on these can be ensured. The crash protection prevents the upper frame, for example the upper frame side parts, from being torn apart, for example in the event of a frontal crash.

The upper frame can, for example, be part of a seat frame of the vehicle seat. The upper frame can, for example, be an upper structural part of a height adjuster and/or rocker frame. The upper frame can form a lower frame or a lower structural part of the vehicle seat, for example the seat frame. In a further embodiment, the upper frame may be fixedly connected to a lower frame portion of the seat frame. Each upper frame side part of an upper frame of a seat adjustment system may be fixedly connected to a seat frame side part of a seat frame, for example a seat base frame.

In an alternative development, the upper frame side part and seat frame side part can be formed in one piece.

In the event of a crash, the seat can be subjected to different forces, wherein the respective side part is fixable as far as possible by a connection that can be established between the crossbar and the insert element, for example by wedging the insert element to the crossbar.

For example, the vehicle seat comprises at least one seat frame with at least two seat frame side parts arranged at a distance from one another in the transverse direction, which are connected to one another via at least one crossbar. For example, at least one of the seat frame side parts may have a protruding insert element as described above.

The vehicle seat is thus locked or blocked against mechanical stresses by means of the insert element and its crash-proof, fixed connection to the crossbar, which is created, for example, by static friction and/or wedging.

In other words, the insert element is a crash safety element. In particular, the insert element is a safety sleeve or a safety bolt. By means of the insert element and the crossbar, a crash safety device is provided in a cost-effective and space-saving manner.

A vehicle seat that is already in use can be retrofitted with such a crash safety device.

The insert element can be screwed to the upper frame side part and/or the seat frame side part, also generally referred to as the side part, via a bolt, for example a screw bolt or via another screw connection element. The bolt can be attached to the corresponding side part via a screw connection. The insert element can be attached to the frame part via the screw connection. The screw connection can be used to reinforce the attachment of the insert element to the corresponding frame part.

The insert element can be used to position the screwed connection between the side part and the bolt. The insert element can be an additional part that reinforces the screwed connection and can absorb loads in the event of a crash. The insert element can comprise a threaded opening and an internally threaded portion. The insert element can be inserted into the front of the crossbar as a threaded insert. The insert element can be designed in the form of a guide bush. In particular, the insert element is accommodated in the cavity of the crossbar contact-free or contactlessly.

The fact that the insert element is attached to the side part, for example an upper frame and/or seat frame, via a screw connection, in particular with the aid of a bolt, means that impact loads or crash loads can be absorbed via the screw connection and via the static friction and/or wedging of the insert element in and/or on the crossbar to increase personal safety. In addition, the stability of the vehicle seat can be ensured in the event of a crash.

In a further development, the crossbar can be held, for example mounted, on the end face in the profile, for example C-shaped or U-shaped profile, of the upper frame side part and/or seat frame side part. The crossbar can extend between the upper frame side parts and/or seat frame side parts.

By screwing the insert element, in particular with the aid of the bolt, to the corresponding side part and a wedging with the crossbar generated in the event of a crash, a deflection and/or deflection of the insert element, and optionally also of the bolt, can be aligned as far as possible in a targeted manner during a load stress so that the corresponding side part does not detach from the crossbar. The connection, in particular structural integrity, between the crossbar and the insert element and thus the connection between the side parts can be maintained under load.

The vehicle seat can be, for example, a truck seat, a vehicle seat of a commercial vehicle and/or an oscillating seat. An oscillating seat or an oscillating rocker is a seat or rocker that can deflect, for example, due to unevenness in the road surface. The suspension seat or suspension arm can counteract unpleasant impacts on poor road surfaces, for example by damping them. This can increase seating comfort, for example on longer journeys.

The seat frame side part and/or the upper frame side part, hereinafter also referred to simply as the side part, can have a threaded opening for connecting the bolt and the crossbar can have an opening on the end face for receiving the insert element. The threaded opening of the side part and the crossbar opening are aligned with each other during the assembly process.

An insert element is arranged in a cavity in the crossbar and protrudes beyond one end of the crossbar. The insert element can be screwed to the bolt. Alternatively, the insert element can have an integrally formed screw element at the end. For example, the end of the insert element can have a closed end with a protruding screw element.

The insert element can take the form of a sleeve, a tube, a rod, a pin or a bolt. The insert element can be an insert tube, an insert sleeve, an insert rod, an insert pin or an insert bolt. The insert element can be made of metal and/or plastic.

The tubular or bolt-shaped insert element can be held in the cavity of the crossbar contact-free or contactlessly.

A dimension, in particular a diameter, of the insert element is dimensioned in such a way that the insert element can be inserted and can be held or is inserted and is held in the cavity of the crossbar contact-free or contactlessly.

The outer diameter of the insert element can be smaller than the inner diameter of the crossbar. The crossbar can be hollow cylindrical, at least on the end face.

The crossbar can be rotatable for seat adjustment.

In a normal position, the insert element can be arranged in the cavity of the crossbar contact-free or contactlessly, in particular without friction, to the crossbar. In the event of a crash, the insert element is displaceable relative to the crossbar into a safety position in which the insert element engages with the crossbar. In the event of a crash, the insert element can be held in the cavity of the crossbar by wedging and/or static friction.

Because the insert element protrudes into the cavity of the crossbar contact-free or contactlessly, the crossbar can be arranged rotatably or in a rotary manner without influencing the insert element. The insert element has no points of contact with the crossbar in the normal position or in normal operation. The insert element can be inserted into the cavity of the crossbar contact-free or contactlessly. In the event of an accident, the insert element can wedge into the crossbar, which can distribute the load.

The insert element is fixed to the side part. In particular, the insert element and the bolt are fixed to the side part.

In an alternative development, the bolt can comprise a thread-free bearing portion which extends through an opening in the seat frame side part provided with a bearing bush for pivoting mounting. The bolt can comprise a bolt head, a thread-free bearing portion and a threaded portion.

The vehicle seat can comprise at least one height adjuster and/or a rocker frame with at least one upper frame and a pair of rocker arms on both sides of the upper frame, wherein the upper frame can be arranged between the two seat frame side parts and connected to them. The height adjuster and/or the rocker frame can, for example, have two pairs of rocker arms arranged at a distance from each other in the transverse direction. A tilt and/or a height of the vehicle seat can be set by adjusting the rocker arms. The rocker frame can be designed as a scissor frame. The rocker frame can be an oscillating and optionally additionally height-adjustable scissor frame. The vehicle seat can be a suspension seat, for example. The rocker frame can be a suspension.

The crossbar can extend between two upper frame side parts and rest with its end faces against the inner surfaces of the upper frame side parts facing each other. The respective upper frame side part can be assigned to a seat frame side part.

The crossbar can have at least one support structure on the end face and outer circumference, which supports the crossbar radially and/or axially in the profile of one of the upper frame side parts. In an alternative exemplary embodiment without an upper frame, the crossbar can be supported radially and/or axially in the profile of a seat frame side part of the seat frame via the support structure.

The support structure can be attached to the end face of the crossbar in the form of a support sleeve and rest with one support end against the end face of the crossbar in order to brace the bolt and/or the insert element against the crossbar. The support structure can be a bearing structure. The bearing structure can be designed to hold the crossbar movably, for example rotatably, in the profile of the upper frame. Alternatively, the support structure can be formed in one piece with the crossbar.

The support structure can comprise a number of radially protruding support ribs and/or a continuous wall. In a development, the support structure can comprise a number of axially protruding support ribs.

Because the crossbar has a support structure on the outer circumference, the connection between the insert element and the crossbar and thus between the crossbar and the corresponding side part can be reinforced to absorb loads in the event of a crash.

### DESCRIPTION OF THE FIGURES

In the following, the invention is explained in greater detail with reference to advantageous exemplary embodiments shown in the figures. However, the invention is not limited to these exemplary embodiments. In the drawings:

FIG. 1: shows a schematic representation of a vehicle seat with a longitudinal adjustment device according to the prior art,

FIG. 2: shows a perspective rear view of a vehicle seat according to the invention,

FIG. 3: shows a schematic sectional view of a seat frame of a vehicle seat in the region of a crossbar connection,

FIG. 4: shows a schematic sectional view of a vehicle seat in the region of a crossbar connection according to a further exemplary embodiment,

FIG. 5: shows a schematic sectional view of a vehicle seat in the region of a crossbar connection according to a further exemplary embodiment, and

FIG. 6: shows a schematic representation of a vehicle seat in a state after load application.

### DETAILED DESCRIPTION

Corresponding parts are provided with the same reference signs in all figures.

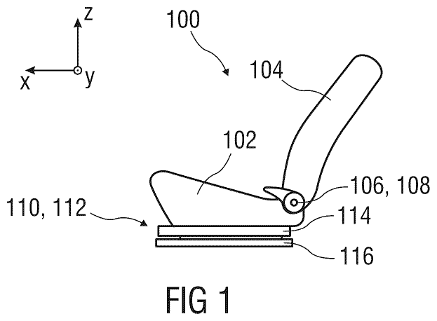

A vehicle seat 100 shown schematically in FIG. 1 relating to the prior art is described below using three spatial directions running perpendicular to each other. In a vehicle seat 100 installed in the vehicle, a longitudinal direction x runs largely horizontally and preferably parallel to a longitudinal direction of the vehicle, which corresponds to the usual direction of travel of the vehicle. A transverse direction y running perpendicular to the longitudinal direction x is also horizontally aligned in the vehicle and runs parallel to a transverse direction of the vehicle. A vertical direction z runs perpendicular to the longitudinal direction x and perpendicular to the transverse direction y. In the case of a vehicle seat 100 installed in the vehicle, the vertical direction z preferably runs parallel to a vehicle vertical axis.

The positional and directional indications used, such as front, rear, upper and lower, refer to a viewing direction of an occupant sitting in the vehicle seat 100 in a normal seat position, wherein the vehicle seat 100 is installed in the vehicle, in a position of use suitable for passenger transportation with the backrest 104 upright and aligned as usual in the direction of travel. However, the vehicle seat 100 can also be installed or moved in a different orientation, for example transverse to the direction of travel. Unless otherwise described, the vehicle seat 100 is constructed with mirror symmetry with respect to a plane extending perpendicular to the transverse direction y.

The backrest 104 can be pivotably arranged on a seat part 102 of the vehicle seat 100. For this purpose, the vehicle seat 100 can optionally comprise a fitting 106, in particular an adjustment fitting, rotary fitting, latching fitting or wobble fitting.

The positional and directional indications used, such as radial, axial and circumferential, refer to an axis of rotation 108 of the fitting 106. Radial means perpendicular to the axis of rotation 108. Axial means in the direction of or parallel to the axis of rotation 108.

The vehicle seat 100 can optionally comprise a longitudinal adjustment device 110. The longitudinal adjustment device 110 comprises, for example, a rail arrangement 112 with a first rail element 114 and a second rail element 116. The first rail element 114 is adjustable relative to the second rail element 116 in the longitudinal direction x. The first rail element 114 is attached to the seat part 102. The second rail element 116 is attached to a structural element of a vehicle, for example a vehicle floor.

For the sake of clarity, the first rail element 114 is referred to as the upper rail 114 in the following description. This upper rail 114 (also referred to as a running rail or slide) is associated with the vehicle seat 100 and is designed to support this vehicle seat 100. The second rail element 116 is referred to below as the lower rail 116. The lower rail 116 is fixed and connected, for example, to the floor of a vehicle.

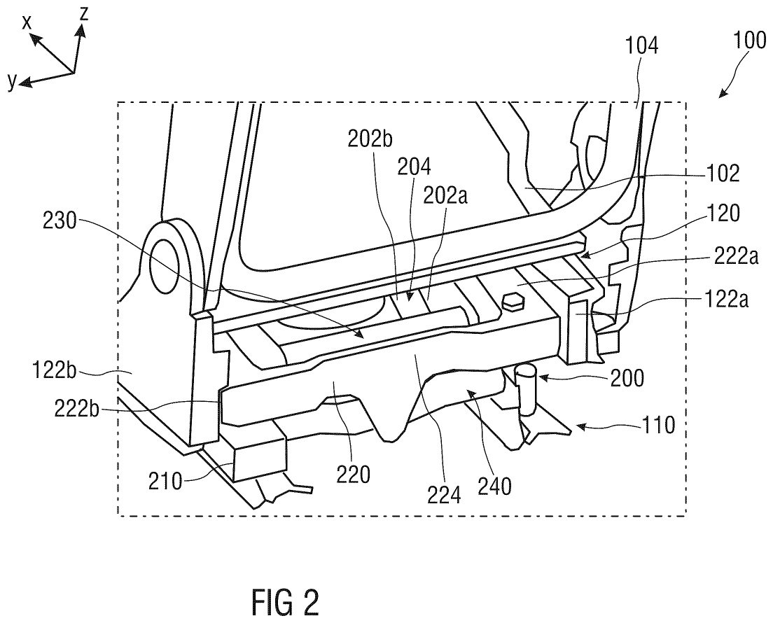

FIG. 2 shows a perspective rear view of a vehicle seat 100 according to the invention.

Between the vehicle seat 100, in particular between the seat part 102, and the longitudinal adjustment device 110 and/or a vehicle floor, there can be arranged a rocker frame 200, for example an oscillating kinematic system and/or height adjustment kinematic system.

The rocker frame 200 can have a joint arrangement, for example a four-joint arrangement, on both sides of the seat part 102. The joint arrangements can have a substantially identical structure.

The seat part 102 can be displaceable together with the rocker frame 200 by means of two pairs of rails, which means that the vehicle seat 100 can be adjustable in translation in the longitudinal direction x. The two pairs of rails are offset from each other in the transverse direction y and are arranged parallel to each other.

The rocker frame 200 can be a scissor frame, for example.

The rocker frame 200 comprises at least a lower frame 210 and an upper frame 220. The lower frame 210 and the upper frame 220 are arranged at a distance from one another in the vertical direction z. The rocker frame 200 comprises a pair of crossed rocker arms 202a, 202b on both sides. The pairs of rocker arms 202a, 202b connect lower frame 210 and upper frame 220 movably to one another. The pairs movably support the upper frame 220 on the lower frame 210.

A scissor axis 204 connects the two crossing points and at the same time defines the axis about which the rocker arms 202a, 202b can pivot relative to one another. The rocker arms 202a, 202b are each hinged at their rear swing end to the lower frame 210 or to the upper frame 220 and each have sliding elements, for example rotatable rollers, not shown in detail, at their front swing end, by means of which they can be guided movably in the longitudinal direction x in or on the upper frame 220 or lower frame 210. This movement of the rocker arms 202a, 202b changes the height of the upper frame 220 above the lower frame 210, also referred to as the height of the scissor frame.

For example, by means of a level control device not shown in detail, for example comprising at least a gas spring and a damper, the scissor frame can be an oscillating system that increases seating comfort.

The two pairs of crossed rocker arms 202a, 202b each comprise a first rocker arm 202a and a second rocker arm 202b, wherein the inner side of the first rocker arm 202a and the outer side of the second rocker arm 202b face each other.

The two first rocker arms 202a are fixedly connected to one another at their upper, in the present case rear, rocker arm ends by means of a crossbar 230. The two first rocker arms 202a can be connected to the upper frame 220 by their rear rocker arm ends. The first rocker arms 202a are connected to one another at their lower, in this case front, rocker arm ends by means of a further crossbar not visible in greater detail.

The second rocker arms 202b are connected to one another at their lower, in this case rear, ends by means of a crossbar 240 and are articulated to the lower frame 210, for example in a movable, in particular rotatable, manner. At their upper, in the present case front, rocker arm ends, the second rocker arms 202b can also be connected by means of a crossbar not visible in greater detail.

The crossbars 230, 240 each run parallel to the scissor axis 204 in the transverse direction y. The height of the upper frame 220 above the lower frame 210 changes as a result of a movement, in particular a pivoting movement, of the first rocker arms 202a relative to the second rocker arms 202b about the scissor axis 204.

The upper crossbar 230 can be connected to the seat frame 120 of the seat part 102 in the case of a seat without an upper frame 220. In the illustrated exemplary embodiment, the crossbar 230 is connected to upper frame side parts 222a, 222b of the upper frame 220.

The upper frame 220 comprises at least two upper frame side parts 222a, 222b and a rear upper frame part 224 connecting the upper frame side parts 222a, 222b. The respective upper frame side part 222a, 222b is associated with a seat frame side part 122a, 122b of the seat frame 120. In particular, one of the seat frame side parts 122a, 122b is attached to one of the upper frame side parts 222a, 222b in each case. By adjusting the rocker arms 202a, 202b, the upper frame 220 and thus the seat frame 120 is adjusted relative to the lower frame 210 and/or a vehicle floor.

The upper frame 220 is arranged between the two seat frame side parts 122a, 122b.

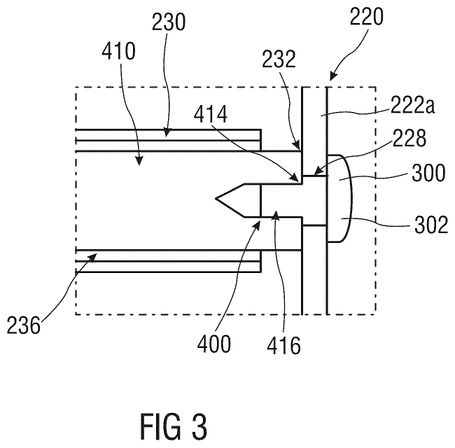

FIG. 3 shows a schematic sectional view of a seat frame 120 of a vehicle seat 100 (shown in FIG. 1) in the region of a crossbar connection, in particular in the region of an upper crossbar 230.

The upper frame 220 comprises at least two upper frame side parts 222a, 222b, which are arranged spaced apart from one another in the transverse direction y and are connected to one another via at least one crossbar 230. At least one of the upper frame side parts 222a, 222b comprises a protruding insert element 410, in particular a crash safety element. The insert element 410 is arranged protruding or projecting on an inwardly directed side of the upper frame side part 222a, 222b. The insert element 410 is fastened to the upper frame side part 222a, 222b via a screw connection 400 and protrudes at least in portions into a cavity 236 of the crossbar 230.

The insert element 410 is arranged in the crossbar 230 in such a way that it projects beyond an end face 232 of the crossbar 230.

In a normal position, the insert element 410 is arranged in the cavity 236 of the crossbar 230 without contact or contactlessly to the crossbar 230. In other words, a space is provided between an outer circumferential surface of the insert element 410 and an inner circumferential surface of the crossbar 230, in particular its cavity 236. In this way, a movement space can be provided in a simple manner in order to allow wedging in the event of a crash, for example a frontal crash.

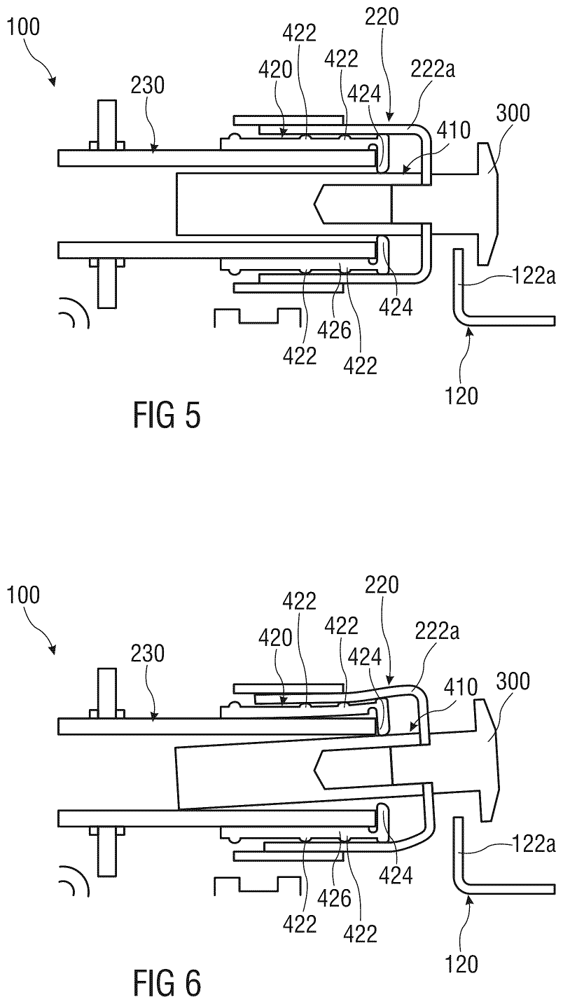

In the event of a crash, the insert element 410 is displaceable relative to the crossbar 230 into a safety position (shown schematically in FIG. 6). In the safety position, the insert element 410 comes into engagement with the crossbar 230, for example static friction engagement and/or wedging engagement. The insert element 410 is moved, for example rotated or pivoted, relative to the crossbar 230 by deformation of the upper frame side part 222a, 222b caused by an accident. The crossbar 230 is a rigid tube, which is arranged in the profile of the upper frame 220.

In the event of a crash, the insert element 410 is held securely in the cavity 236 of the crossbar 230 by wedging and/or static friction.

The insert element 410 is designed as a safety sleeve or safety bolt.

The insert element 410 is attached to the upper frame side part 222a, 222b via a bolt 300. The bolt 300 is screwed to the insert element 410 and the upper frame side part 222a, 222b.

For example, the upper frame side part 222a, 222b comprises an opening 228, for example a threaded opening, for screwing in the bolt 300. The insert element 410 comprises a threaded opening 414 and an internally threaded portion 416. The insert element 410 is designed as a threaded insert and is inserted into the crossbar 230 at the end face thereof. The bolt 300 comprises a bolt head 302 which, in the bolted state with the insert element 410, bears against an outer surface of the upper frame side part 222a, 222b facing away from the insert element 410. The insert element 410 is fixedly held on the upper frame side part 222a, 222b via the bolt 300. The end face of the insert element 410 rests against an inner surface of the upper frame side part 222a, 222b facing it.

The end face of the insert element 410 is thus connected to at least one of the upper frame side parts 222a, 222b via a bolt 300. A free end face of the insert element 410 protrudes into the cavity 236 of the crossbar 230.

In a development, an insert element 410 is provided on each of the two upper frame side parts 222a, 222b. Each insert element 410 can be connected to a corresponding upper frame side part 222a, 222b via a screw connection 400, in particular with the aid of a corresponding bolt 300. The crossbar 230 extends between the upper frame side parts 222a, 222b or the corresponding seat frame side parts 122a, 122b.

The crossbar 230 is, for example, a cross tube, a crossbar or a cross rod.

Because the insert element 410 is attached to the upper frame side part 222a, 222b via a screw connection 400, impact loads or crash loads can be absorbed via the screw connection 400 to increase personal safety. In addition, the insert element 410 can be wedged against and/or in the crossbar 230 and a tearing apart of the upper frame side parts 222a, 222b and thus of the seat frame 120 connected to them can be prevented. The insert element 410 can increase the stability of the vehicle seat 100. By screwing the insert element 410, in particular with the aid of a bolt 300, a flexing and/or deflection of the bolt 300 during a load stress can be reduced and thus a separation of the upper frame side part 222a, 222b from the crossbar 230 can be prevented.

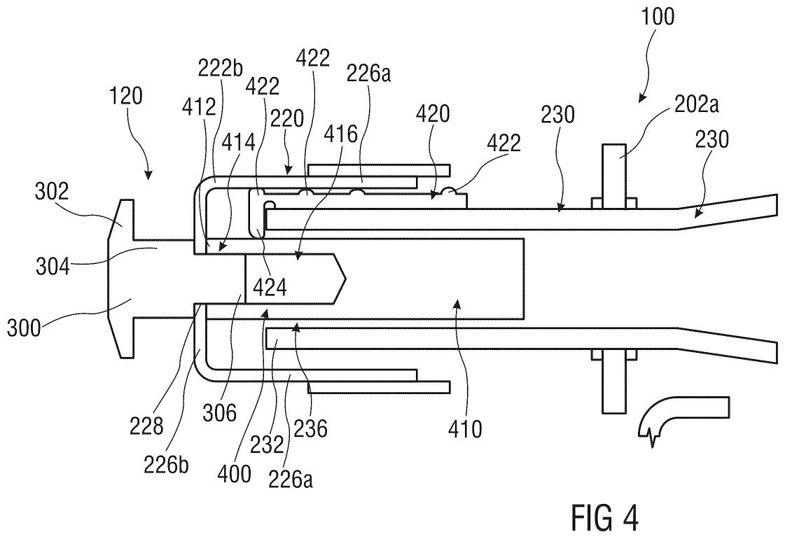

FIG. 4 shows a schematic sectional view of a vehicle seat 100 in the region of a crossbar connection according to a further exemplary embodiment.

The crossbar 230 is arranged at the end face in the C-profile or U-profile of the upper frame side part 222a, 222b. The crossbar 230 can be rotatably mounted in the C-profile or U-profile of the upper frame side part 222a, 222b.

For example, FIG. 4 shows an insert element 410 arranged on the left-hand side with a screw connection 400 on the upper frame 220, wherein it is clear that the upper frame 220 can have an identical insert element 410 on the right-hand side.

The crossbar 230 comprises a cavity 236 with an insert element 410 arranged therein, in particular inserted, introduced or plugged in.

The insert element 410 is arranged in the crossbar 230 in such a way that it projects beyond an end face 232 of the crossbar 230. The insert element 410 is in a screw connection 400 with the bolt 300.

The insert element 410 comprises a threaded opening 414 and an internally threaded portion 416. The insert element 410 is designed as a threaded insert and is inserted into the end face of the crossbar 230.

The bolt 300 comprises a bolt head 302 which, in the screwed state with the insert element 410, bears against an outer surface of the seat frame side part 122a, 122b facing the bolt head 302. The bolt 300 may comprise a thread-free bearing portion 304. The bolt 300 comprises a threaded portion 306, which can be brought or is brought into threaded engagement with the internally threaded portion 416 of the insert element 410.

The crossbar 230 can extend on the end face in portions through a profile of the upper frame 220, in particular of the upper frame side part 222a, 222b. The upper frame side part 222a, 222b may, for example, have a substantially U-shaped profile. The upper frame side part 222a, 222b may, for example, comprise two parallel opposing legs 226a and a web 226b connecting the legs 226a. An opening 228 may be formed in the web 226b for passage and/or screwing of the bolt 300. The upper frame side part 222a, 222b may be oriented such that the web 226b extends parallel to the seat frame side part 122a, 122b. The legs 226a run parallel to the crossbar 230.

In the exemplary embodiment shown, the insert element 410 rests with its end face 412 against an inner surface of the upper frame side part 222a, 222b facing the end face 412. According to the exemplary embodiment shown in FIG. 3, the insert element 410 can rest with its end face 412 against an inner surface of the seat frame side part 122a, 122b facing the end face 412.

In the region of the insert element 410 and/or the screw connection 400, the crossbar 230 has at least one support structure 420 on the outer circumference, which can support the crossbar 230 radially and/or axially in the profile of one of the upper frame side parts 222a, 222b. The support structure 420 can be designed as a sleeve half. The support structure 420 can extend in the axial direction of the crossbar 230 over an end-face portion of the crossbar 230 and be connected to an outer circumference of the crossbar 230.

The support structure 420 comprises a number of radially projecting support ribs 422, which are designed to at least radially support the crossbar 230 in the profile of the upper frame side part 222a, 222b, for example with respect to the legs 226a. In the event of a crash, the support structure 420 can absorb loads.

The support structure 420 rests with a support end 424 against the end face 232 of the crossbar 230. In the illustrated exemplary embodiment, the support structure 420 embraces the open end face 232 of the crossbar 230 at least in portions in order to brace the insert element 410 against the crossbar 230 and against the profile of the upper frame side part 222a, 222b in the event of a crash.

The support structure 420 may be formed in one part with the crossbar 230, wherein an outer peripheral surface of the crossbar 230 is provided, for example, with grooves or slots to form support ribs 422.

The support structure 420 may be in frictional engagement with inner surfaces of the profile of the upper frame side part 222a, 222b. For example, the support structure 420 can brace the crossbar 230 and/or the insert element 410 against slippage of the crossbar 230 in the axial direction of the crossbar 230 (or in the transverse direction y) under load and/or during a screwing operation.

FIG. 5 shows a schematic sectional view of a vehicle seat 100 in the region of the insert element 410 according to a further exemplary embodiment.

For example, FIG. 5 shows a right-sided screw connection 400 on the upper frame 220, wherein it is clear that the upper frame 220 can have an identical or different connection to the crossbar 230 on the left side.

In the illustrated exemplary embodiment, the support structure 420 is designed as a support sleeve. The support structure 420 comprises a sleeve body 426. The sleeve body 426 can be provided with radially projecting support ribs 422 on the outer circumference. The support ribs 422 can be formed radially continuously around the sleeve body 426. The support structure 420 is attached to the end face of the crossbar 230. A support end 424 of the support sleeve rests against the end face 232 of the crossbar 230 in order to brace the insert element 410 against the crossbar 230.

FIG. 6 shows a schematic representation of a vehicle seat 100 in a state after a load has been applied.

The screw connection 400 between the insert element 410, the bolt 300 and the upper frame side part 222a, 222b can reduce flexing and/or deflection and/or a tear-out between the individual components during a load stress. In particular, the insert element 410 is a rigid component. In the event of a crash, the upper frame side part 222a, 222b is deformed in portions, for example, due to a force being applied via the seat frame 120 connected to the upper frame 220. In the process, the insert element 410 is twisted relative to the crossbar 230 until wedging takes place, which prevents further displacement and/or tearing out of the upper frame 220 or the seat frame 120 relative to the crossbar 230 and relative to an attachment supporting the crossbar 230.

### LIST OF REFERENCE SIGNS

100 vehicle seat
102 seat part
104 backrest
106 fitting
108 axis of rotation
110 longitudinal adjustment device
112 rail arrangement
114 first rail element (upper rail)
116 second rail element (lower rail)
120 seat frame
122a, 122b seat frame side part
200 rocker frame
202a, 202b rocker arm
204 scissor axis
210 lower frame
220 upper frame
222a, 222b upper frame side part
224 upper frame part
226a leg
226b web
228 opening
230 crossbar
232 end face
236 cavity
240 crossbar
300 bolt
302 bolt head
304 bearing portion
306 threaded portion
400 screw connection
410 insert element
412 end face
414 threaded opening
416 internally threaded portion
420 support structure
422 support rib
424 support end
426 sleeve body
x longitudinal direction
y transverse direction
z vertical direction

What is claimed is:

1. A vehicle seat, comprising at least one upper frame with at least two upper frame side parts which are arranged at a distance from one another in the transverse direction and are connected to one another via at least one crossbar,
wherein at least one of the upper frame side parts comprises a protruding insert element, the insert element being fastened to the upper frame side part via a screw connection and protruding at least in portions into a cavity of the crossbar.

2. The vehicle seat as claimed in claim 1, wherein, in a normal position, the insert element is arranged in the cavity of the crossbar with no contact with the crossbar.

3. The vehicle seat as claimed in claim 1 wherein, in the event of a crash, the insert element is displaceable relative to the crossbar into a safety position in which the insert element comes into engagement with the crossbar.

4. The vehicle seat as claimed in claim 1, wherein, in the event of a crash, the insert element is held securely in the cavity of the crossbar by wedging and/or static friction.

5. The vehicle seat as claimed in claim 1, wherein the insert element is designed as a safety sleeve or safety bolt.

6. The vehicle seat as claimed in claim 1, wherein the insert element is attached to the upper frame side part via a bolt, the bolt being screwed to the insert element and the upper frame side part.

7. The vehicle seat as claimed in claim 1, wherein the insert element comprises a threaded opening and an internally threaded portion and is inserted into the crossbar as a threaded insert at the end face thereof.

8. The vehicle seat as claimed in claim 1, wherein the crossbar has at least one support structure on the outer circumference, by means of which the crossbar is supported radially and/or axially in the profile of the upper frame.

9. The vehicle seat as claimed in claim 8, wherein the support structure is mounted as a support sleeve on the end face of the crossbar in order to brace the crossbar against the profile of the upper frame.

10. The vehicle seat as claimed in claim 9, wherein the support structure comprises a number of radially projecting support ribs and/or a continuous wall.
